(19) United States
(12) Patent Application Publication
(10) Pub. No.: US 2002/0192999 A1
(43) Pub. Date: Dec. 19, 2002

(54) Connection system for flexible flat strip cables with cam

(76) Inventors: Hans-Otto Geltsch, Sindlbach (DE); Michael Hopf, Nurnberg (DE)

Correspondence Address: PERMAN & GREEN, 425 POST ROAD, FAIRFIELD, CT, 06824, US

(21) Appl. No.: 10/137,877

(22) Filed: May 1, 2002

(30) Foreign Application Priority Data
May 2, 2001 (DE) 10121307

(51) Int. Cl. H01R 12/24

(52) U.S. Cl. 439/498

(57) ABSTRACT

The present invention relates to a connection system for the connection of a branch flexible flat strip cable (1b) comprising a principal flexible flat strip cable (1a), by means of a cam (3), arranged in a housing (2), for pressing areas of contact of cables against one another (1a,1b), those being areas of the cable from which insulation has been stripped.

### BACKGROUND OF THE INVENTION

1. Field of the Invention

The present invention relates to a connection system for flexible flat strip cables, which are increasingly being used in motor vehicles, where they distribute signals and power to individual consuming points sensors and the like, into a system of principal flat strip cables and branch flat strip cables.

2. Description of Prior Developments

Since different wiring diagrams with connection systems are required according to equipment variant and accessories, there is a need for a flexible connection system, which makes it possible to connect branch conductors simply and rapidly to where they are needed. At the same time, it should be possible to make secure contact at low contact resistance.

### SUMMARY OF THE INVENTION

The present invention accordingly has the purpose of providing a connection system of the type as explained above which, given simple and rapid handling and an uncomplicated construction, makes it possible to make secure contact at low contact resistance.

The present invention is based on the idea of locally stripping the insulation from the flexible flat strip cables and of pressing the stripped areas against one another by means of the cam, where the corresponding areas of contact are pressed against one another by means of the cam and during the process of the closing of the cam, the areas of contact rub against one another over a short distance, so that they clean one another, whereby the contact resistance is reduced.

### BRIEF DESCRIPTION OF THE DRAWINGS

The invention is explained in greater detail by means of the description of a preferred embodiment example and by reference to the following drawings:

FIG. 1 shows a perspective view of an embodiment example of the flexible connection system according to the invention;

FIG. 2 shows two cross-sectional views of the cam, respectively in the front lock-in and end lock-in position; and

FIG. 3a to e shows the process of assembly, when connecting the connection system to a principal flexible strip cable.

### DETAILED DESCRIPTION OF THE PREFERRED EMBODIMENTS

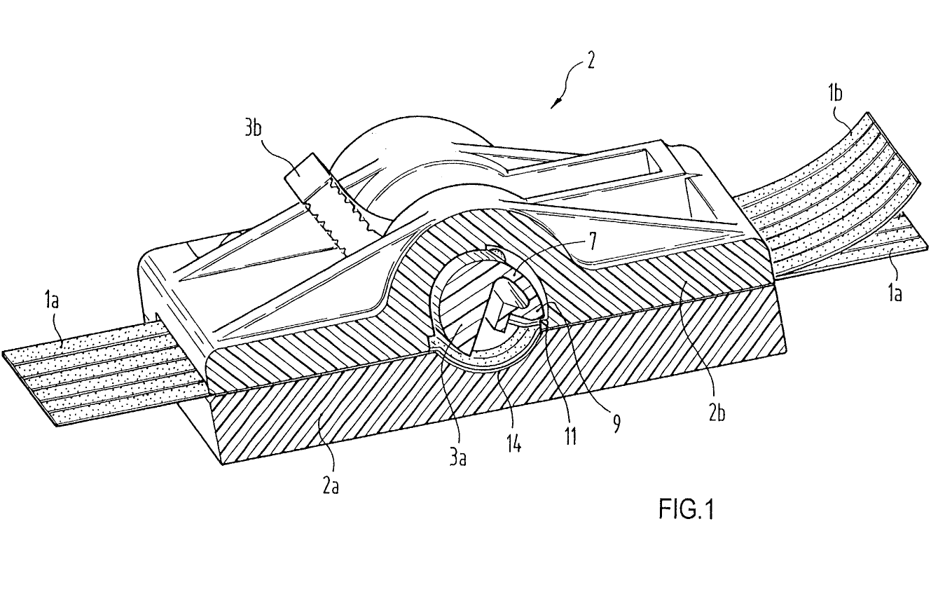

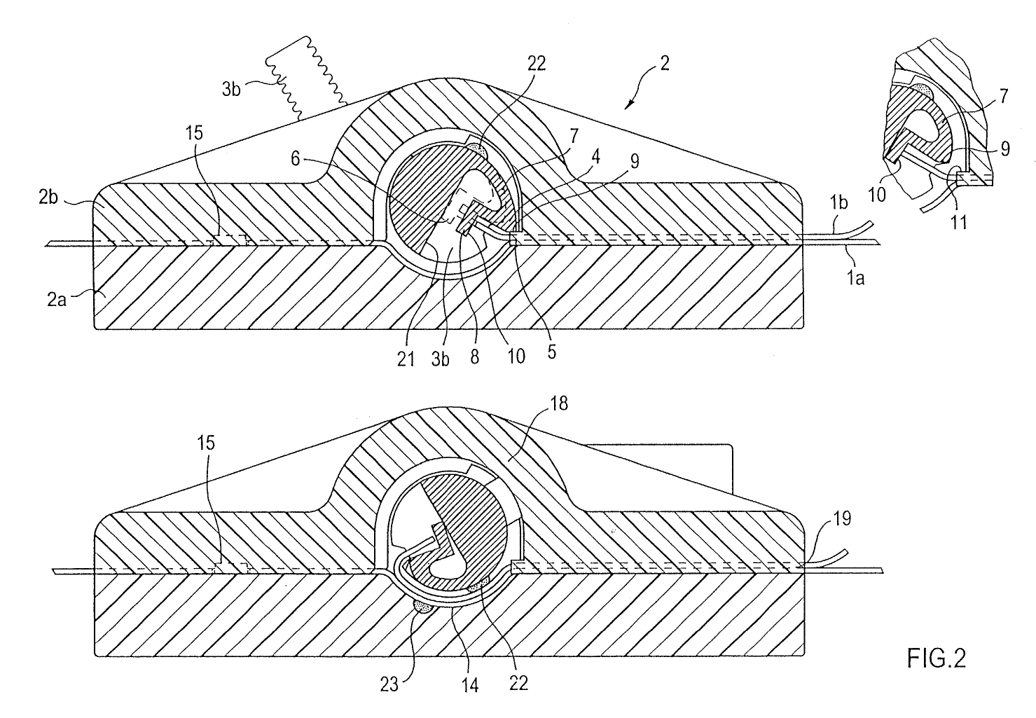

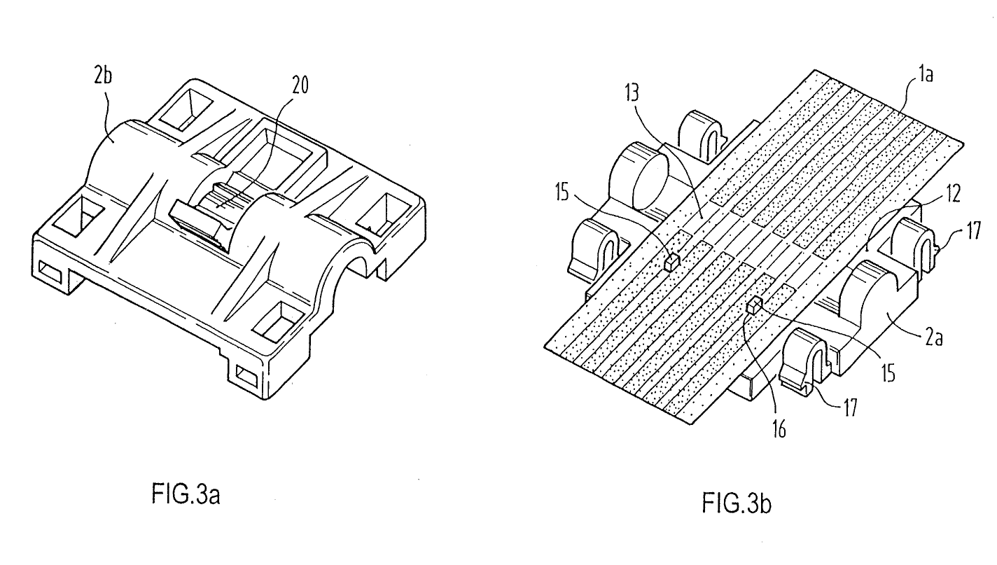

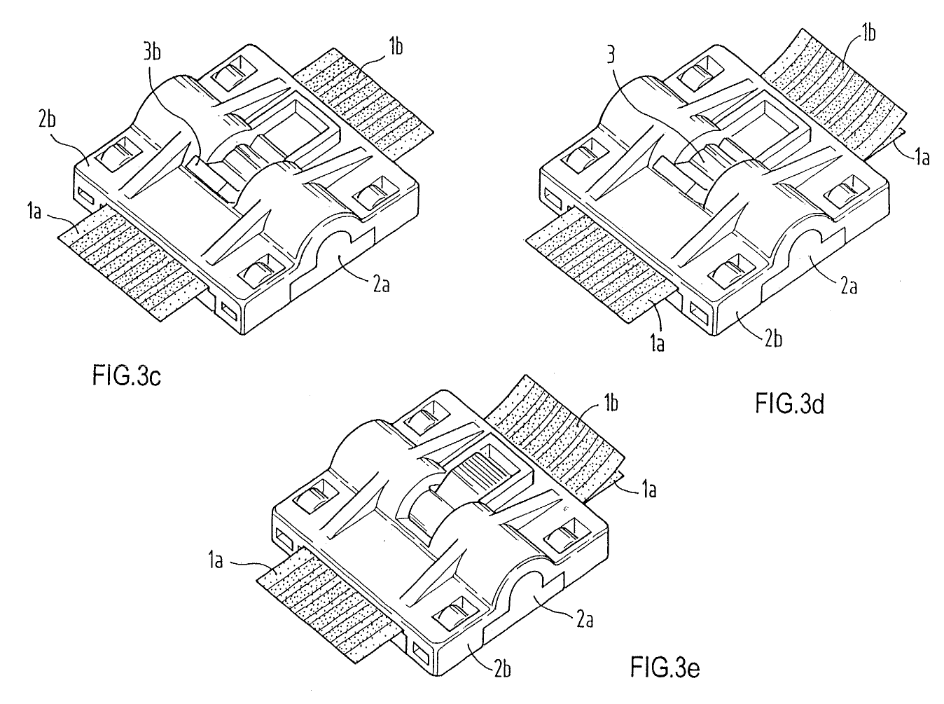

FIG. 1 shows the cam 3 in its housing 2, through which a principal flexible flat strip cable 1a is led, on whose right side a branch flexible flat strip cable 1b is placed, which is introduced into the housing 2 as far as the cam and pressed by the latter in the area of contact onto the principal flexible flat strip cable 1a. The housing 2 consists of a lower part 2a and an upper part 2b, which are connected with one another by means of locking elements 17 shown in FIG. 3b, but not in FIG. 1. A groove 14 in the shape of a cylinder is formed into the lower part 2a of the housing, which represents a part of the bearing of cam 3. The cam 3 has a drum 3a and a lever 3b. The drum 3a is, as can best be seen in FIG. 2, executed in one-half of the cross-section and in the other half of the cross-section the drum cover surface is formed by a flexible arm 7 extending over rather more than a quadrant of a circle. Its free end is bent radially towards the centre point of the drum and when the flexible arm 7 is relaxed, ends at a certain distance from the flat surface of the complete circle segment. The free end of the flexible arm 7 also has an impact surface 10 for the front edge of the branch flexible flat strip cable 1b. This is inserted via the principal cable 1a into the housing 2, until it impinges on the impact surface 10. By means of continuing insertion of the branch cable 1b until the impact surface 10 itself has impinged on surface 21, the flexible arm 7 is bent so far inwards that its edge 9 is led away by a shoulder 11 which together form a click-and-pawl mechanism, so that the drum can be rotated by means of actuating the lever 3b into the end lock-in position shown in the lower part of FIG. 2. The shoulder 11 is arranged in the upper part 2b of the housing, somewhat above the level at which the principal cable 1a is substantially led into the housing. When the drum is rotated, the branch cable 1b is pulled by the drum and that part of it which has been stripped of its insulation slides over the area of the principal cable 1a, which has likewise been stripped of its insulation. By means of the eccentric cross section of the drum 3a, the pressure whereby the area of the branch cable 1b is being pressed on the area 13 of the principal cable 1a which has likewise been stripped of its insulation, gradually becomes greater, until the end lock-in position has been reached. This mutual friction between the areas from which insulation has been stripped removes dirt, so that the contact resistance of the area of contact is reduced.

In order to increase the frictional adhesion between the cam drum 3a and the branch cable 1b, a transverse rib 23 made from an elastomer or silicone or the like is formed into the cover surface of the drum 3a.

FIG. 3 shows the process of assembly of the connection system. FIG. 3a shows the upper housing part 2b. FIG. 3b shows the lower housing part 2a, with the principal cable 1a lying inside it. Its part 13 from which insulation has been stripped lies in the vicinity of the cylinder cover segment-shaped groove 14. For exact positioning, locking stops 15 are provided in the reception area for the principal cable 1a, which snap into the corresponding punched openings in the principal cable 1a. Following the insertion of the principal cable 1a into the floor 12 of the lower housing part 2a, the upper housing part 2b is inserted onto the lower housing part 2a and locked with the latter by means of locking hooks 17. The upper housing part 2b has on one of its sides a reception slot 19 for the branch cable 1b (FIG. 3a) into which the branch cable 1b is inserted, until the impact surface 10 impinges on the surface 21 (FIG. 3c, d). As can be seen in FIG. 2, this releases the ratchet mechanism 9,11, so that the cam lever 3b can be shifted into the end lock-in position. FIG. 3e shows the cam in its end lock-in position shown in the lower part of FIG. 2. In this position, the areas of contact of the flexible flat strip cables 1a,1b, which are to be connected, lie on top of one another and are pressed against one another by the flexible arm 7 and the transverse rib 22 which is arranged thereon.

The loosening of the connection between the branch cable 1b and the principal cable 1a takes place in reverse order, without requiring any special tools.

In this way, it is possible to make the connection rapidly and using a simple means, where good contact is established between the cables 1a, 1b, which are to be connected with one another by means of the high pressure on the areas of contact and the prior friction between the said areas of contact.

What is claimed is:

1. A connection system for the connection of a branch flexible flat strip cable comprising a principal flexible flat strip cable with a cam arranged in a housing, adapted for the pressing against one another of areas of the cables which are stripped from insulation.

2. A connection system according to claim 1, wherein said cam includes a click and pawl mechanism, which only allows a change from a loosened position into an end position, when said branch flexible flat strip cable is introduced into a cam drum until it meets a stop.

3. A connection system according to claim 2, wherein said cam drum, forms in its cross-section an open circle segment, which is partially closed by an elastic arm forming part of a drum cover, whose free end is bent toward the axis of said drum with the formation of a locking edge, and has an impact surface for the front edge of said branch flexible flat strip cable, where the flexible arm reduces, by means of pressing of said branch flexible flat strip cable against the impact surface, the radial distance of its locking edge from said drum axis, so that the locking edge rotates past a locking shoulder correspondingly formed in said housing and said cam can be shifted into a locked position.

4. A connection system according to claim 3, wherein said housing includes a lower part with a floor for the reception and the fixing of the position of said principal flexible flat strip cable, such that the area from which insulation has been stripped, lies in a transverse groove which forms part of said cam bearing, with locking stops for the adjustment of the position of said cable via correspondingly punched openings and with locking hooks for the fastening of an upper part of said housing.

5. A connection system according to claim 4, wherein said housing has an upper part with a cam bearing, introduction slots for the branch flexible flat strip cables and an opening for the introduction of the operating lever of the cam.

6. A connection system according to claim 5, wherein said locking shoulder is arranged in said upper housing part of said housing for locking the rotating movement of said cam.

7. A connection system according to claim 2, wherein a free end of an elastic arm impinges against a surface of a circular segment-shaped cut-out of said cam and thus defines the exact positioning of said branch flexible flat strip cable with respect to said housing.

8. A connection system according to claim 1, wherein said cam winds said branch flexible flat strip cable during its rotation, into its end position on a flexible arm and the areas of contact of said cables rub against one another.

9. A connection system according to claim 2, wherein a flexible arm has on its outer face an elastomer or silicone transversal rib, in order to improve adhesion.

10. A connection system according to claim 4, wherein said groove in said lower part of said housing has an elastomer or silicone transversal rib in order to improve adhesion.
